(19) United States
(12) Patent Application Publication
(10) Pub. No.: US 2007/0263391 A1
(43) Pub. Date: Nov. 15, 2007

(54) Light emitting diode information display unit

(76) Inventor: Andrew Kuenhwa Tong, Rochester, MI (US)

Correspondence Address: ANDREW KUENHAWA TONG, 1571 PEBBLE CREEK DRIVE, ROCHESTER, MI, 48307, US

(21) Appl. No.: 11/800,808

(22) Filed: May 8, 2007

Related U.S. Application Data
(60) Provisional application No. 60/799,402, filed on May 11, 2006.

(51) Int. Cl. F21V 7/00

(52) U.S. Cl. 362/341

(57) ABSTRACT

This invention is related to an information display unit, especially a number display unit, comprising light-emitting diodes (LED) as the source of the light for either direct or indirect display of the light. In one embodiment of this invention for a direct display, the light emitted by the LED is made more focused by a tunnel device with reflective inner wall; and under another embodiment of the invention of an indirect display the light emitted by the LED is made smooth by a filtering means.

### CROSS REFERENCE TO RELATED APPLICATIONS

This application claims the benefit of the priority date of U.S. Provisional Patent Application No. 60/799,402, titled Light Emitting Diode Information Display Unit, filed May 11, 2006.

### BACKGROUND OF THE INVENTION

1. Field of the Invention

This invention relates generally to an information display system and, more particularly, to an information display system that employs light-emitting diodes to provide light-emitting elements for advertisement of information.

2. Discussion of the Related Art

Information display through source of light takes various types of light sources; each has its strengths and weaknesses. For example, light source with significant level of power such as incandescent lights or neon lights makes the display of information well visible but it also consumes significant power and is difficult to be packaged into a flat panel for most of the desired functionality.

On the other hand, light source with low level of power such as liquid crystal display can be packaged into flat panel but it can hardly be well viewed under any well-lighted environment. Light-emitting diode (LED) is one light source promising of low-power consumption with enough light intensity as well as feasibility of thin packaging for number displays.

However, the LED light emission suffers the problem of scattering to be less effective in any direction. Furthermore, due to the nature of LED when it is packaged into a flat panel the light intensity emitting out of the panel is far from uniform and can be undesirable. It is therefore the purpose of this invention to provide means to work with the LED's so it can be used to provide the light with more focused light intensity in one embodiment, and to provide the light with more uniform intensity in another embodiment.

### SUMMARY OF THE INVENTION

In accordance with the teachings of the present invention, an information display unit utilizing light-emitting diodes is improved over the prior art with a cover panel comprising of beveled tunnel openings with reflective inner surface to refocus the scattered light emitted from each light-emitting diode. The light-emitting diodes are also used to form a lighting panel with array of the light-emitting diode where the emitted light is made more uniform with a filter panel covering over the lighting panel.

Additional features of the present invention will become apparent from the following description and appended claims, taken in conjunction with the accompanying drawings. Note that the use of LED in this application signifies light-emitting diodes or light-emitting diode, i.e., the plural or singular form of this noun phrase expression.

### BRIEF DESCRIPTION OF THE DRAWINGS

FIG. 1 shows a diagram of a typical LED light intensity with respect to the viewing angle in a polar coordinate form;

FIG. 2 shows an illustration of a cover panel with beveled tunnel to be placed on top of the LED for display according to this invention;

FIG. 3 shows a plan view of the beveled tunnel with respect to the LED;

FIG. 4 shows an example of the LED display assembled according to this invention;

FIG. 5 shows an LED array panel with a filter panel on top thereof;

FIG. 6 shows the comparison of light intensity along an LED array with and without the filter panel;

FIG. 7 shows another example of the LED display assembled according to this invention;

FIG. 8 shows an example of a prior-art LED display assembled without the benefit of this invention;

FIG. 9 shows the fully assembled light emitting diode information display unit contained within a housing; and

FIG. 10 shows a typical LED power supply within the housing in a partial cut-away drawing.

### DETAILED DESCRIPTION OF THE EMBODIMENTS

The following discussion of the embodiments of the invention directed to an LED display is merely exemplary in nature, and is in no way intended to limit the invention or its applications or uses.

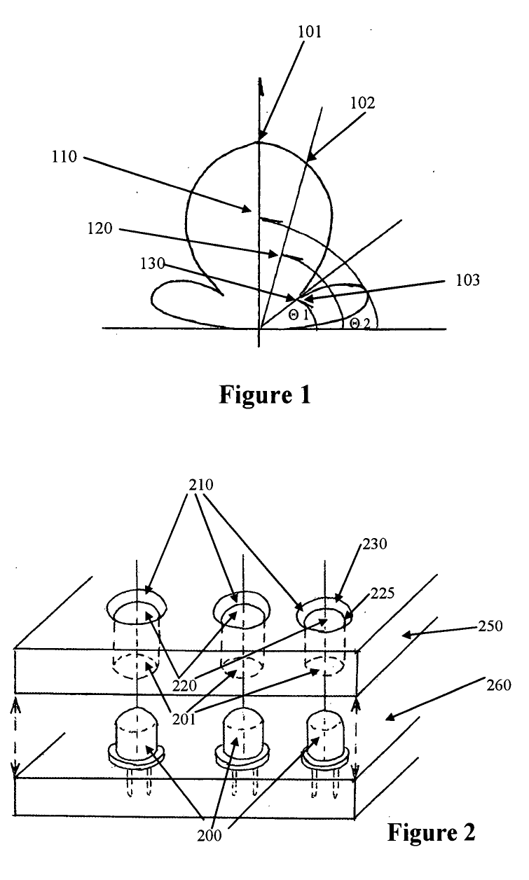

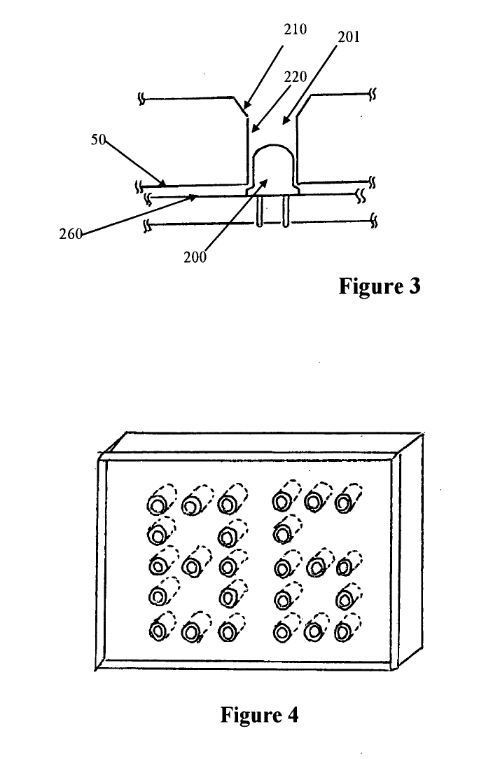

In an ideal display of light the light source emits the light only in one direction completely focused toward the direction of view, such as achieved using laser. However, using LED has display of light does not naturally have such advantage. FIG. 1 shows that the intensity of the LED light emission varies according to the viewing angle. Moreover, FIG. 1 shows the LED light intensity emitted to different viewing angles in a polar-coordinate form. For example, at the direct front of 90 degrees angle from the horizontal plane 110, the light intensity is at its highest level 101. At an angle less than 90 degrees 120, the light intensity is at a lower level 102. At another angle farther away from the direct front 130, the light intensity can come to a local minimum 103, yet, it can increase after passing this angle. The fact that the light intensity is non-zero long the angles away from the direct front means light scattering away resulting in waste of light energy as well as light displaying effectiveness. In order to increase the light displaying effectiveness it is essential to have the scattered light refocused to the direct front angle. According to this invention, as illustrated in FIG. 2, a cover panel 250 can be placed on top of the LED panel 260. The cover panel 250 has openings 201 corresponding to the locations of the LED 200 on the LED panel 260. The opening 201 is constructed to have an inner surface 220 which is capable of reflecting light. The opening 201 further has a beveled end 210 resulting in a further wider outer opening 230 than the inner tunnel 225 of the opening 201. FIG. 3 illustrates the relative location of the LED 200 and the opening 201, as well as the inner surface of the opening 220 and the beveled opening 210.

The LED panel and the cover panel arranged according to this invention can be assembled together to form an information display unit with LED's directly emit the better focused light to the viewer at the direct front of the LED's, as illustrated in FIG. 4. The reflective inner surface of the cover panel openings serves the purpose of re-directing the otherwise scattered lights to the front, and the beveled opening permits the re-focused lights to be viewed from an angle away from the direct front.

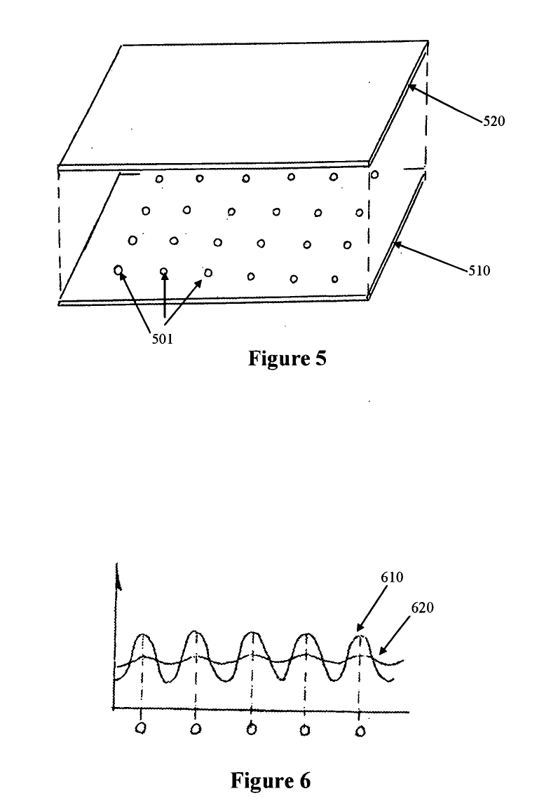

FIG. 5 illustrates another embodiment of this invention. The LED's can be placed in an array over a flat-panel board to serve as a light source panel 510. However, due to the apparent distance from one LED to another the light cannot be uniformly emitted. As shown in FIG. 6, the light intensity 610 varies along the line of the LED array. To make the light intensity uniform, a filter panel 520 is applied on top of the LED light source panel 510. As a result, the light from the LED 501 going through the filter panel 520 become diffused, and the intensity becomes much more uniform 620 as illustrated in FIG. 6.

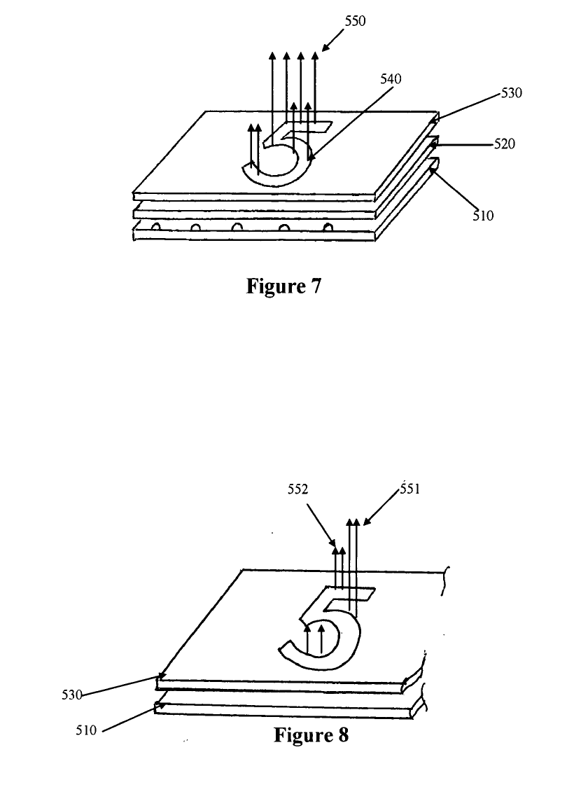

The LED light source panel 510 and the filter panel 520 can be assembled with an information display panel 530 according to this invention, as illustrated in FIG. 7. The information display panel 530 is made of opaque material with an opening area 540 permitting the light to emit through for the information to be displayed. FIG. 7 also illustrates the advantage of the filter panel according to this invention resulting in a fairly uniform emission 550 of the light, as in contrast with the prior art assembly of the similar construction of information display (FIG. 8) resulting in a non-uniform light intensity 552 as compared to the normal light intensity 551.

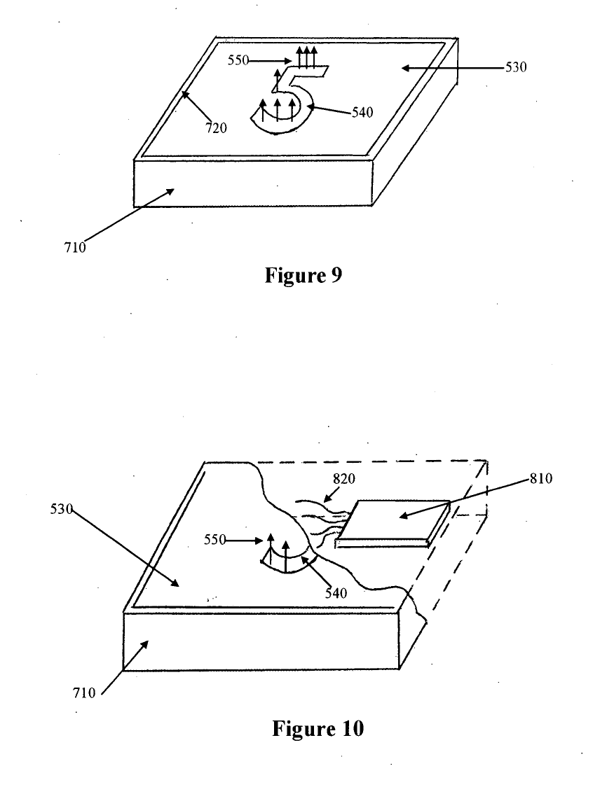

FIG. 9 shows that the respective panels in FIGS. 2, 5 and 7 are preferably contained in a housing 710. The housing 710 in FIG. 9 is rectangular, however, any shape of housing is possible, for example, oval, circular, etc., or a combination of shapes thereof. Moreover, said housing 710 may contain display panel 530, i.e., the outer most panel, within a recessed boundary margin area 720, or said display panel 530 may be flush with said housing.

FIG. 10 illustrates that within said housing 710 and under information display panel 530 of FIG. 7, one would find a power supply 810 providing current to the LED's 200, seen in FIG. 2. Not shown in their entirety are a plurality of wires 820 originating from said power supply 810 to LED's 200 located on light source panel 510, however, these would be necessary to provide current to said LED's. The power supply 810 may be an inductive power pickup, any direct current device, a battery, an alternating current supply or the like.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A light emitting diode information display unit, comprising:
a panel (A) having a plurality of light-emitting diodes;
a cover panel (B) having a plurality of openings at substantially the same location corresponding to said light-emitting diodes, said cover panel
(B) disposed parallel to said panel (A); and
a housing containing said panel (A) and said cover panel (B).

2. The light emitting diode information display unit of claim 1 wherein said openings on said cover panel have light-reflective inner surfaces.

3. The light emitting diode information display unit of claim 1 wherein said openings have beveled outer openings at the surface plane of said cover panel.

4. A light emitting diode information display unit, comprising:
a panel (A) having an uniformly arranged array of light-emitting diodes;
a filter panel (C) substantially covering the area of said light-emitting diode array; and
an information display panel (D) having a plurality of openings to permit light transmission,
wherein said panel (A), said filter panel (C) and said information display panel (D) are situated in a parallel spaced arrangement and contained within a housing.
